(19) United States
(12) Patent Application Publication
(10) Pub. No.: US 2003/0107652 A1
(43) Pub. Date: Jun. 12, 2003

(54) Dental video camera

(76) Inventor: Ronald R. Williams, Camino, CA (US)

Correspondence Address: W. Edward Johansen, 11661 San Vicente Boulevard, Los Angeles, CA, 90049, US

(21) Appl. No.: 09/994,388

(22) Filed: Nov. 26, 2001

Related U.S. Application Data
(63) Continuation-in-part of application No. 08/969,107, filed on Nov. 13, 1997, now abandoned.
Application No. 08/969,107 is a continuation-in-part of application No. 08/816,447, filed on Mar. 12, 1997, now abandoned.
Application No. 08/816,447 is a continuation-in-part of application No. 08/560,397, filed on Nov. 17, 1995, now Pat. No. 5,771,067.
Application No. 08/560,397 is a continuation-in-part of application No. 08/426,119, filed on Apr. 20, 1995, now Pat. No. 5,737,013.
Application No. 08/426,119 is a continuation-in-part of application No. 08/303,019, filed on Sep. 8, 1994, now Pat. No. 5,523,782.
Application No. 08/303,019 is a continuation-in-part of application No. 07/943,716, filed on Sep. 11, 1992, now abandoned.

(51) Int. Cl. H04N 5/225

(52) U.S. Cl. 348/207.99

(57) ABSTRACT

A dental video camera includes a housing, a charge coupled device that is disposed within and slidably coupled to the elongated cavity of the housing at said proximal end thereof, a plurality of light emitting diodes that are optically coupled to the charge coupled device, a sleeve that is slidably coupled to the housing. The sleeve is able to move laterally back and forth and has achromatic lenses and fixed lenses. The sleeve engages the charge coupled device so that the sleeve laterally moves the charge coupled device back and forth in order to change the position of the charge coupled device with respect to the achromatic lenses and fixed lenses thereby changing the field of focus. A mechanism bi-directionally drives the sleeve laterally to produce back and forth lateral movements.

This is a continuation-in-part of the application filed on Nov. 13, 1997 under Ser. No. 08/969,107, which is a continuation-in-part of the application filed on Mar. 12, 1997 under Ser. No. 08/816,447, which is a continuation-in-part of the application filed on Nov. 827, 1995 under Ser. No. 08/560,397, now U.S. Pat. No. 5,771,067, which is a continuation-in-part of the application filed on Apr. 20, 1995 under Ser. No. 08/426,119, now U.S. Pat. No. 5,737,013, which is a continuation-in-part of the application filed on Sep. 8, 1994 under Ser. No. 08/303,019, now U.S. Pat. No. 5,523,782, which is a continuation-in-part of the application filed on Sep. 11, 1992 under Ser. No. 07/943,716.

### BACKGROUND OF THE INVENTION

The field of the invention is dental video cameras.

U.S. Pat. No. 6,190,309 teaches a video scope that has an entry section which can advance into an object; and a grip section which is disposed at the back of the entry section and to be held by an operator. The video scope includes a light-reflecting body, an objective-lens, a solid-state image-pickup device, a light source, a window of incidence for image pickup rays and illumination windows that are located in the vicinities of the window of incidence. A power source is disposed in the grip section for driving the light source. A portable accommodation case has an accommodation space for accommodating the video scope. A lid has a thin display attached thereto and can rotate freely and stop at an optional position. The thin display is capable of displaying an image that is picked up by the video scope.

U.S. Pat. No. 5,908,294 teaches a hand-held dental video camera which includes a window for receiving light. In some aspects of the invention, a lamp is mounted distally beyond the window and aimed to illuminate a subject. A white light emitting diode is used to illuminate the subject.

U.S. Pat. No. 5,523,782 teaches a video dental camera that includes a light source, a charge coupled device and an adjustable focus lens system. Other examples of existing system can be found in U.S. Pat. No. 4,575,805 and U.S. Pat. No. 5,527,261. Until now, however, it has been extremely difficult to fashion a sufficiently slim instrument. Slim instruments are desirable because they provide accessibility to places that thicker instruments can not reach. Moreover, even in cases where a thick instrument can provide adequate access, the slimmer instruments can reduce the discomfort experienced by the patient. One factor contributing to the thickness of previous dental video cameras is the type of light source that is incorporated into the camera head.

U.S. Pat. No. 5,429,502 teaches a dental camera that uses an external light source and route the light from the source to the head using fiber optics. In this arrangement the optical fibers travel through the cable and through the body of the handheld camera unit thereby resulting in a stiffer cable reducing maneuverability and a thicker handheld unit. The fiber optic connections require a complex and expensive connector as compared to fully electrical connectors. Using fiber optics to illuminate the subject requires increased power because some of the light energy is lost in the optical fiber.

There are imaging devices that use lamps at the end of the imaging head instead of fiber optics. These lamps have not been used in configurations that minimize the thickness of the instrument. The lamps in the dental camera of U.S. Pat. No. 5,523,782 are positioned axially away from the imaging window. The lamp in the dental camera of U.S. Pat. No. 4,575,805 is positioned on the proximal side of the imaging window. Both of these configurations result in relatively thick instruments. In addition, the lamps used in previous imaging devices had significant shortcomings. A halogen lamp that is used in the dental camera of U.S. Pat. No. 5,527,261 consumes significant power and generates heat. The lighting emitting device (LED) that are used The lamp in the dental camera of U.S. Pat. No. 4,575,805, like all ordinary light emitting diodes, produces essentially monochromatic light that can make diagnosis of certain medical conditions difficult.

U.S. Pat. No. 5,124,797 teaches a video-imaging camera that has a detachable distal module that is replaceable with one of different characteristics and sterilizable. A non-replaceable charge coupled device and a video transmitter are connected to an inner body that includes a lens tube. The module includes an outer body encasing the inner body. The inner body may have a filter at its tip and a magnifying lens optically connected to an image conduit optical segment. The inner body receives an image conduit. The lens focuses the output of the image conduit and is disposed in the inner body on a charge coupled device microprocessor. The model may be replaced with an angular distal end or lenses of different fields of view. Fiber optic light filaments may be used to illuminate the field of view of the tip of the module, either housed internally or externally of the inner body.

U.S. Pat. No. 4,300,167 teaches an automatic iris control system which connected between a video camera and optical input device which produces an optical image from a light directed upon and reflected from a subject. The optical image is directed onto the surface of an electronic imaging tube in the video camera. The optical image has a wide variation of reflected light due to variations in distance of the subject from the light source. The automatic iris control system has an adjustable iris and a drive motor. The drive motor is located between the surface of the electronic imaging tube. An optical input device dynamically varies the intensity of the optical image applied to the electronic imaging tube of the video camera. A light intensity programming circuit establishes a desired light intensity level on the surface of the electronic imaging tube of the video camera and an automatic iris control circuit. The automatic iris control circuit has a low gain amplifier, a weighted peak response detector, a comparator and a circuit. The circuit controls the current to the iris drive motor and a circuit for providing a feedback signal representing the direction in which the iris must be adjusted by the motor to control the light intensity on the surface of the electronic imaging tube of the video camera is shown.

U.S. Pat. No. 5,047,847 teaches a liquid crystal assembly. The assembly forms at least a part of an image optical system. The assembly includes a plurality of liquid crystals. The liquid crystal have a refractive index anisotropy and different response frequencies of molecule orientation so that the transitivity and refractive index of the plurality of liquid crystals may be independently controlled with few signal lines by varying the frequency of the driving signal applied to the liquid crystal assembly.

U.S. Pat. No. 5,296,944 teaches an image scanner. The image scanner includes a light source that illuminates an original document, an image sensor that receives a reflected light from the original document and converts the same into an output signal of image data, a device that relatively moves the original document and the image sensor, an iris mechanism that is provided on an optical path between the original document and the image sensor, a reference reflection plane that is provided such that a light from the light source is reflected and the reflection light becomes incident on the image sensor, a comparing circuit that compares a level of an output signal from the image sensor with a reference level when the image sensor receives the light from the reference reflection plane and a device for correcting a dynamic range of the image scanner by controlling the iris mechanism on the basis of the compared output.

U.S. Pat. No. 5,124,797 teaches a dental video camera. The dental video camera includes a proximal housing and a distal module consists of a body containing a magnifying lens, a filter and an optical fiber image conduit. The distal module is sterilizable. The proximal housing which is unable to withstand autoclaving does not require sterilization since it does not contact the patient.

U.S. Pat. No. 4,919,114 teaches an endoscope. The endoscope includes a solid state imaging device and a flexible insertable part for insertion into a body cavity. The solid-state imaging device obtains an optical image of an observed part through an observing window provided in a tip part of the flexible insertable part.

U.S. Pat. No. 4,858,001 teaches a hand held endoscopic apparatus which consists of a body, a camera and a removable and interchangeable objective element which is capable of presenting an image of an object to the camera. An optically transparent sheath is capable of isolating the endoscope from the working environment.

U.S. Pat. No. 4,727,416 teaches a video dental camera which includes a handle, a camera head and a mirror. The camera head is located at the distal end of the handle with the camera head being disposed at an angle to the handle.

U.S. Pat. No. 4,757,381 teaches sheaths which are dispensed on a perforated role. Each sheath prevents a dental camera from coming into contact with the patient, while allowing the dental camera to function properly.

U.S. Pat. No. 4,914,521 teaches a sterilizable video camera cover. The cover has a connector and a receptacle. The connector has a guide-way for receiving a video camera within a predetermined fixed orientation and serves as a bacteria barrier. The receptacle holds the video camera against a window at the distal end of the connector.

U.S. Pat. No. 4,915,626 teaches a dental video camera which is used to view an image of the interior of the mouth of a patient. The dental video camera displays contemporaneously a video image of the interior of the mouth.

U.S. Pat. No. 4,589,404 teaches a laser endoscope. The laser endoscope includes a video camera and an optical system. The video camera transmits an image through the optical system.

U.S. Pat. No. 4,600,939 and U.S. Pat. No. 4,639,772 teach a highly compact focusable video camera which includes an optical system, a sensor-converter and a video electronic processing circuit. The sensor-converter receives an optical image passing through the optical system and converts the optical image to an unprocessed video signal. The video electronic processing circuit processes the unprocessed video signal.

U.S. Pat. No. 4,837,615 teaches a hand held optical probe. The probe includes a light source, two bundles of optical fibers for directing light axially into a fastener hole. The tip end of each bundle being directed at a right angle to the axis of the fastener hole so that the panel edges are illuminated.

U.S. Pat. No. 5,604,531

teaches an in vivo video camera system which includes a swallowable capsule, a transmitter, a light emitting diode and a reception system. The swallowable capsule includes a camera system and an optical system for imaging an area of interest onto the camera system. The transmitter transmits the video output of the camera system and the reception system receives the transmitted video output.

U.S. Pat. No. 5,527,261 teaches a hand-held, fully remote diagnostic instrument having video capability which is configured for any one of a number of clinical or industrial applications. The instrument has a casing that includes a hand-holdable body portion, a neck portion that extends from the body portion to a head portion that is formed of a back cover, a front cover, and a sealing gasket to form a fully soakable instrument. A circuit board assembly in the body portion contains video processing circuitry and a flexible neck board. The neck board extends forward from the body portion through the neck portion of the casing to a headboard located in the head portion of the casing. A solid state imager and a miniature lamp are disposed on the headboard. The front cover contains an adjustable focus lens cell for focusing on the imager an image of a target in the lens cell's field of view. The instrument can be configured for various applications by installing front and back covers that are suited for a specific purpose. The instrument can thus be used as a dental camera. The instrument provides a monitor-ready, standard format, full color video signal to a remotely located monitor.

### SUMMARY OF INVENTION

The present invention is generally directed to a dental video camera. The dental video camera includes a housing, an adjustably focusing lens and a charge coupled device camera system. The adjustably focusing lens, the charge coupled device camera system and the fixed focusing lens system are all disposed in the housing.

In a first aspect of the present invention, the dental video camera includes an electrically adjustable iris that is optically coupled to the adjustably focusing lens system. The adjustably focusing lens provides a focusing adjustment between a near field of focus and a far field of focus. The electrically adjustable iris is adjusted between a nearly closed opening and a wide open opening in response to the focusing adjustment between the near field of focus and the far field of focus.

In a second aspect of the present invention, the dental video camera includes a light source that is disposed in the elongated cavity of the housing.

In a third aspect of the present invention, the light source is at least one lamp that provides direct illumination.

Other aspects and many of the attendant advantages will be more readily appreciated as the same becomes better understood by reference to the following detailed description and considered in connection with the accompanying drawing in which like reference symbols designate like parts throughout the figures.

The features of the present invention which are believed to be novel are set forth with particularity in the appended claims.

### BRIEF DESCRIPTION OF THE DRAWINGS

FIG. 1 is a perspective view of a dental video camera.

FIG. 2 is a side elevation in cross-section of a fragmented distal portion or the dental video camera of FIG. 1 taken along the line 2-2 or FIG. 4.

FIG. 3 is a side elevation in cross-section of the proximal portion of the dental video camera of FIG. 1 taken along the line 3-3 of FIG. 4.

FIG. 4 is a top plan view in cross-section of the fragmented distal portion of the dental video camera of FIG. 1 taken along the line 4-4 of FIG. 2.

FIG. 5 is a cross-sectional view of the fragmented distal portion of the dental video camera of FIG. 1 taken along the line 5-5 of FIG. 4.

FIG. 6 is a cross-sectional view of the dental video camera of FIG. 1 taken along the line 6-6 of FIG. 2.

FIG. 7 is a cross-sectional view of the dental video camera of FIG. 1 taken along the line 7-7 of FIG. 2.

FIG. 8 is a cross-sectional view of the dental video camera of FIG. 1 taken along the line 8-8 of FIG. 3.

FIG. 9 is a cross-sectional view of a remote control transmitter for use with the dental video camera of FIG. 1 taken along line 9-9 of FIG. 10.

FIG. 10 is a cross-sectional view of the remote control transmitter of FIG. 9.

FIG. 11 is a side elevation in cross-section of a fragmented distal portion of a dental video.

FIG. 12 is a cross-sectional view of the dental video camera of FIG. 11 taken along the line 12-12 of FIG. 11.

FIG. 13 is a side elevation in cross-section of a fragmented distal portion of a dental video camera.

FIG. 14 is a cross-sectional view of the dental video camera of FIG. 13 taken along the line 14-14 of FIG. 13.

FIG. 15 is a cross-sectional view of the dental video camera of FIG. 13 taken along the line 15-15 of FIG. 13.

FIG. 16 is a side elevation in cross-section of a fragmented distal portion of a dental video camera.

FIG. 17 is a block diagram of an in vivo video camera system that is constructed and operative in accordance with U.S. Pat. No. 5,604,531.

FIG. 18 is a schematic diagram of a video camera capsule forming part of the in vivo video camera system of FIG. 17.

FIG. 19 is a side elevation in cross-section of an optical system within the distal portion of a dental video camera with an adjustable iris.

FIG. 20 is a transverse view in cross-section of of the distal portion of the dental video camera with the adjustable iris of FIG. 19 when the knob has been rotated clockwise forty-five degrees from the neutral position.

FIG. 21 is a side elevation in cross-section of the mechanical system of the distal portion of the dental video camera with the adjustable iris of FIG. 19 taken along line 21-21 of FIG. 20.

FIG. 22 is a side elevation in cross-section of a video scope camera that is constructed and operative in accordance with U.S. Pat. No. 5,745,165.

FIG. 23 is a side elevation in cross-section of a video scope camera that is constructed and operative in accordance with U.S. Pat. No.

FIG. 24 is a side elevation in cross-section of a hand-piece that is constructed and operative in accordance with U.S. Pat. No. 5,908,294.

FIG. 25 is a partial, enlarged side elevation in cross-section of the hand-piece of FIG. 24.

FIG. 26 is a partial, enlarged top plan view of the hand-piece of FIG. 24.

FIG. 27 is a top plan view of a video scope that is constructed and operative in accordance with U.S. Pat. No. 6,190,309.

FIG. 28 is a top plan view in cross-section of the video scope of FIG. 27.

FIG. 29 is a side elevation in cross-section of the video scope of FIG. 27

FIG. 30 is a partial, enlarged perspective view of the video scope of FIG. 27.

FIG. 31 is a partial, enlarged side elevation of the video scope of FIG. 27.

FIG. 32 is a top perspective view of a dental video camera according to the present invention.

FIG. 33 is a bottom perspective view of the dental video camera of FIG. 32.

FIG. 34 is a side elevation in cross-section of the dental video camera of FIG. 32.

FIG. 35 is a top perspective view in cross-section of the dental video camera of FIG. 32 that includes a focused camera assembly with a charge coupled device and a cable connector assembly.

FIG. 36 is a top plan view of the focused camera assembly of FIG. 35 that includes an electrical circuit, a focusing lens system and a flexible coupler that electrically couples the electrical circuit to the charge coupled device.

FIG. 37 is a side elevation of the focused camera assembly of FIG. 35.

FIG. 38 is a side elevation of the focusing lens system of FIG. 36 that includes a slidable portion and a fixed portion.

FIG. 39 is an exploded perspective of the slidable portion of the focusing lens system of FIG. 38.

FIG. 40 is an exploded perspective of the fixed portion of the focusing lens system of FIG. 38.

FIG. 41 is a proximal elevation of the cable connector assembly of FIG. 35.

FIG. 42 is a distal perspective view of the cable connector assembly of FIG. 35.

FIG. 43 is a side elevation of the cable connector assembly of FIG. 35.

FIG. 44 is an end elevation of a cable that electrically couples to the cable connector assembly of FIG. 35.

FIG. 45 is a partial side elevation of the cable of FIG. 44.

### DESCRIPTION OF THE PREFERRED EMBODIMENTS

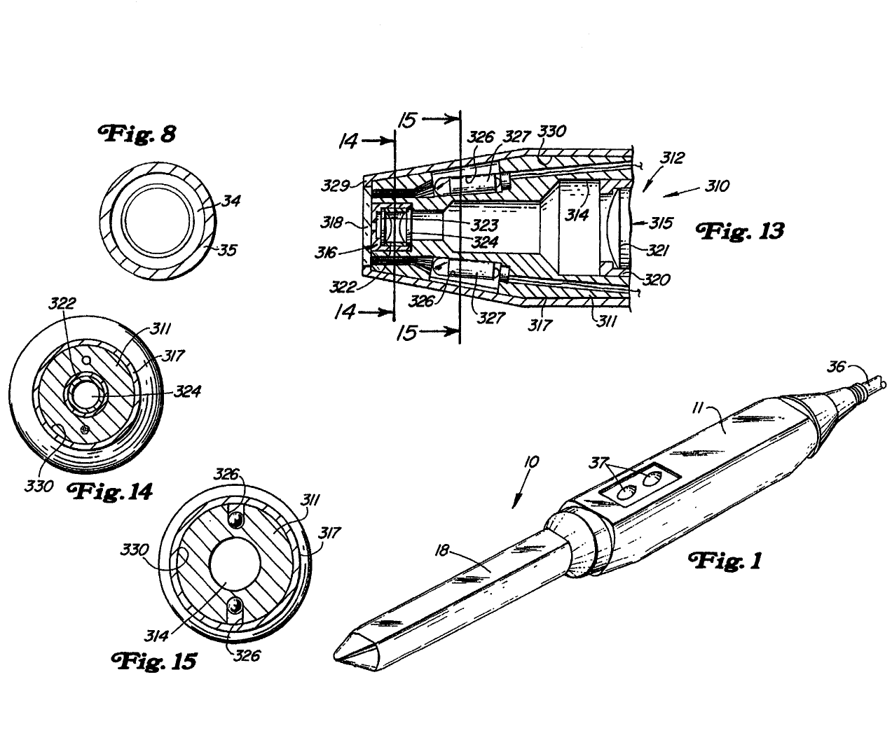

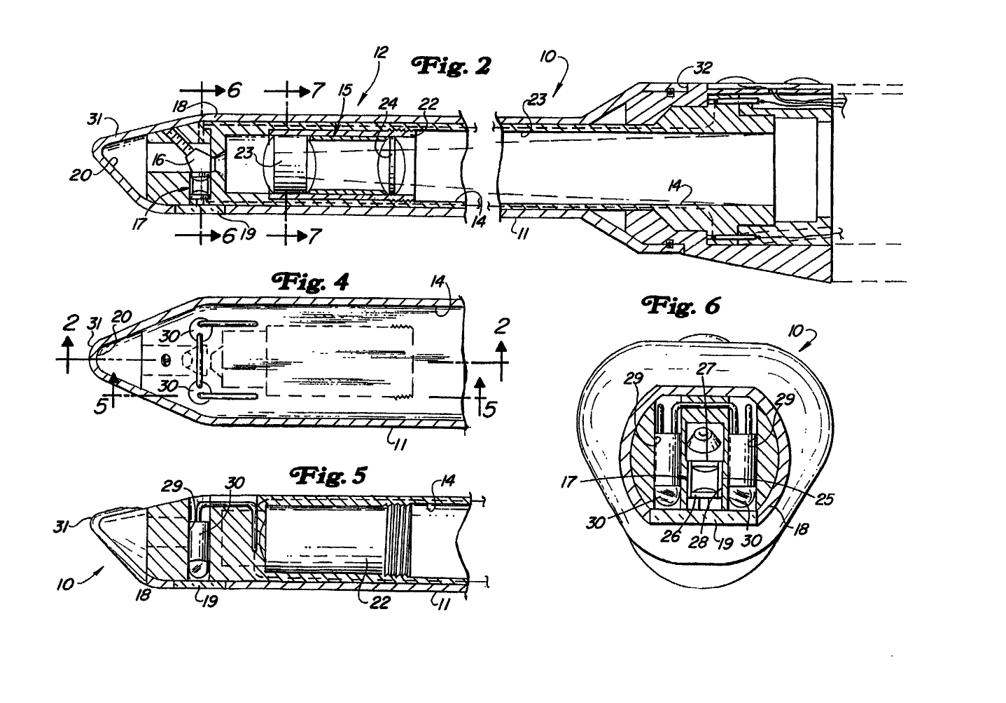

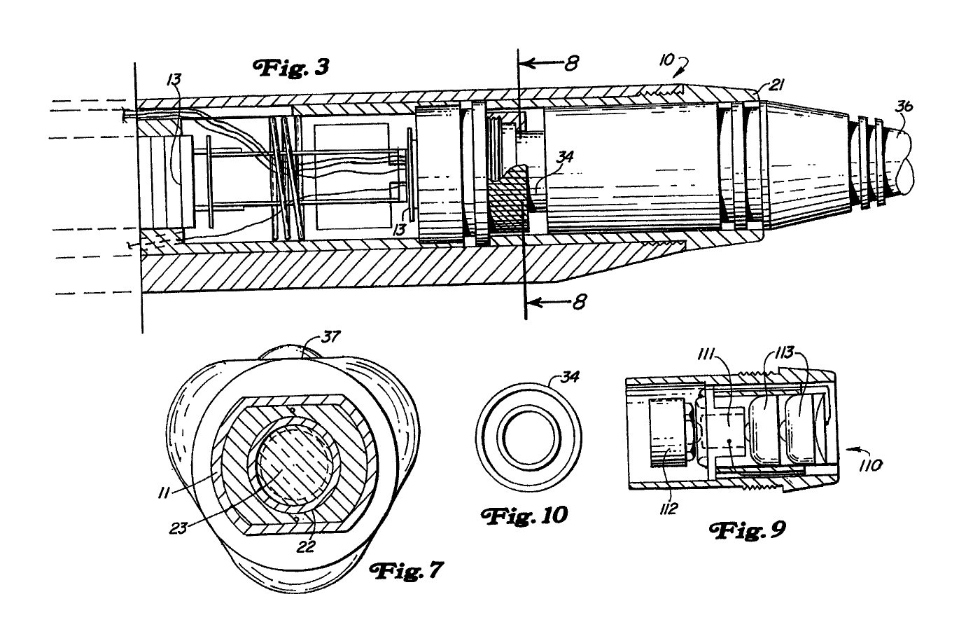

Referring to FIG. 1 in conjunction with FIG. 2 and FIG. 3 a dental video camera 10 includes housing 11, an optical system 12 and a charge coupled device camera 13. The housing 11 has an elongated cavity 14 that has a distal portion and a proximal portion. The optical system 12 is disposed in the distal portion of the elongated cavity 14 of the housing 11. The charge coupled device camera 13 is disposed in the proximal portion of the elongated cavity 14 of the housing 11. The optical system 12 includes an adjustably focusing lens system 15, a penta-prism 16, a fixed focusing lens system 17 and a sheath 18 which has an optical window 19. The housing 11 has a distal end 20 and a proximal end 21. The penta-prism 16 may be replaced with another optical element that can deflect, deviate, invert or rotate an image. The adjustably focusing lens system 15 includes a first sleeve 22, a first achromatic lens 23 and a second achromatic lens 24. The adjustably focusing lens system 15 may include only a single achromatic lens. A singlet lens, a doublet lens or triplet lens may replace the first achromatic lens 23. The first and second achromatic lenses 23 and 24 are disposed in the first sleeve 22 and are optically coupled to the charge coupled device camera 13. The adjustably focusing lens system 15 is disposed within the elongated cavity 14 of the housing 11 at the distal end 20.

Referring to FIG. 4 in conjunction with FIG. 5 and FIG. 6 the fixed focusing lens system 17 includes a second sleeve 25, a first micro-lens 26 and a second micro-lens 27. The first and second micro-lenses 26 and 27 are disposed in the second sleeve 25. The penta-prism 16 optically couples the fixed focusing lens system 17 to the adjustably focusing lens system 15. The elongated cavity 14 of the housing 11 has a bore 28 that is orthogonally disposed thereto at the distal end 20 thereof. The fixed focusing lens system 17 is disposed within the bore 28. The housing 11 further has two parallel orthogonally disposed cavities 29 at its distal end 20. The internal surfaces of the two parallel-orthogonally disposed cavities 29 are either polished or plated. They act as reflectors in order to direct heat toward the optical window 19 of the sheath 18 in order to defog the optical window 19 and minimize heat build-up within housing 11 at the distal end 20. The dental video camera 10 also includes two lamps 30 that are disposed in the two inwardly angled, orthogonally disposed cavities 29 of the housing 11. The housing 11 dissipates heat from the two lamps 30 that provide both direct illumination and anti-fogging control through the optical window 19 of the sheath 18. The sheath 18 has a distal end 31, a proximal end 32 and an elongated cavity 33. The housing 11 is removably inserted into the elongated cavity 33 of the sheath 18.

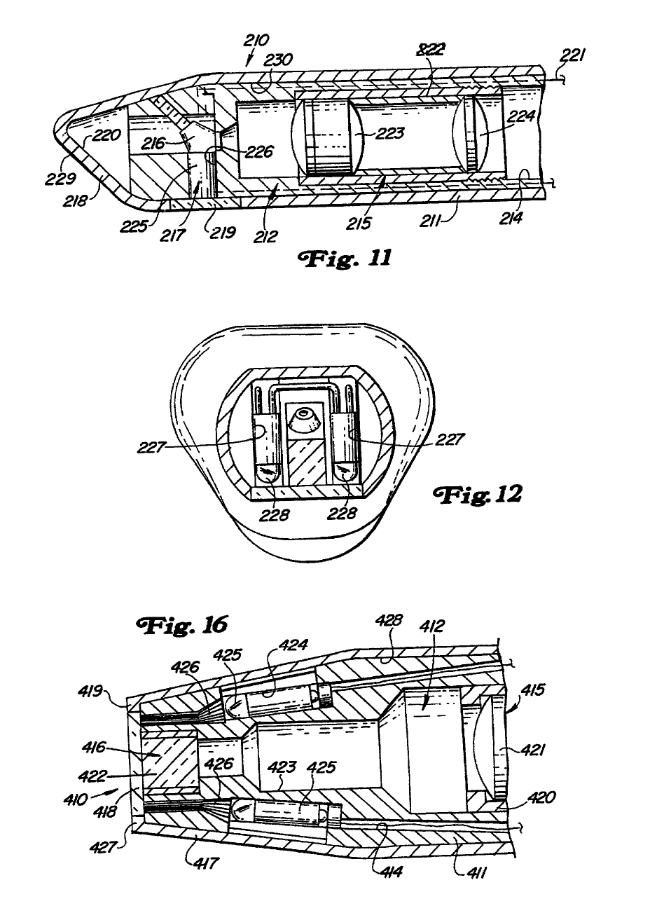

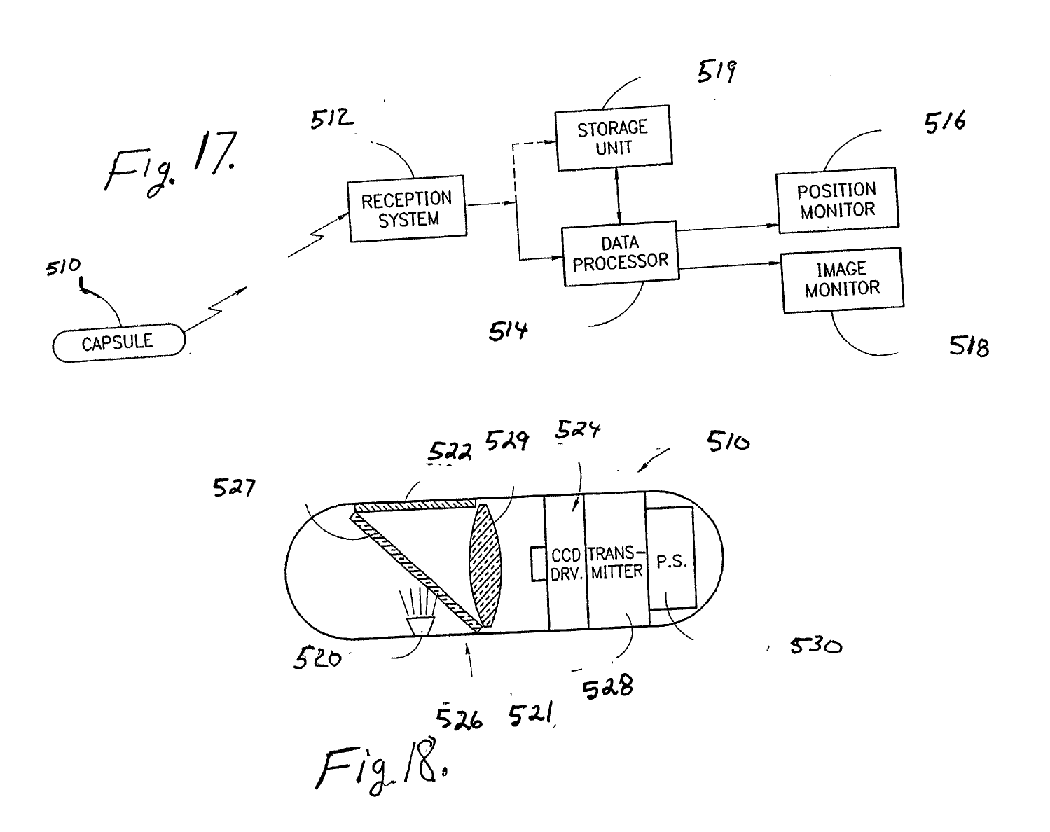

Referring to FIG. 2 in conjunction with FIG. 3 and FIG. 7 the adjustably focusing lens system 15 is optically coupled to the charge coupled device camera 13. The penta-prism 16 optically couples the fixed focusing lens system 17 to the adjustably focusing lens system 15. The optical window 19 of the sheath 18 is optically aligned and optically coupled to the fixed focusing lens system 17.

Referring to FIG. 3 in conjunction with FIG. 8 the dental video camera 10 further includes a multiple-pin male connector 34, a multiple-pin female connector 35, a cable 36 and external switches 37. The multiple-pin male connector 34 is electrically coupled to the multiple-pin female connector 35. The multiple-pin female connector 35 is electrically coupled to the cable 36. The cable 36 has a plurality of wires which connect the external switches 37 to a video processor, a recording device and a thermal printer to the charge coupled device camera 13 and the two lamps 30 to a power source.

Referring to FIG. 9 in conjunction with FIG. 3 and FIG. 10 a dental video camera 110 includes a remote control transmitter 111. The remote control transmitter 111 has a multiple-pin female connector 112 and two batteries 113. The batteries 113 are either rechargeable or replaceable and are a source of power to the two lamps 30. The multiple-pin male connector 34 is electrically coupled to the multiple-pin female connector 112 of the remote control transmitter 111. A receiver remotely couples the thermal printer, the video processor and the recording device to the remote control transmitter 111 so that one of the external switches 37 controls each of the thermal printer, the video processor and the recording device.

Referring to FIG. 11 in conjunction with FIG. 12 a dental video camera 210 includes housing 211, an optical system 212 and a charge coupled device camera. The housing 211 has an elongated cavity 214 that has a distal portion and a proximal portion. The optical system 212 is disposed in the distal portion of the elongated cavity 214 of the housing 211. The charge coupled device camera is disposed in the proximal portion of the elongated cavity 214 of the housing 211. The optical system 212 includes a adjustably focusing lens system 215, a penta-prism 216, a fixed focusing lens system 217 and a sheath 218 which has an optical window 219. The housing 211 has a distal end 220 and a proximal end 221. The adjustably focusing lens system 215 includes a first sleeve 222, a first achromatic lens 223 and a second achromatic lens 224. A singlet lens, a doublet lens or a triplet lens may replace the first achromatic lens 223. The first and second achromatic lenses 223 and 224 are disposed in the first sleeve 222 and are optically coupled to the charge coupled device camera. The adjustably focusing lens system 215 is disposed within the elongated cavity 214 of the housing 211 at the distal end 220. The penta-prism 216 may be replaced with another optical element that can deflect, deviate, invert or rotate an image. The fixed focusing lens system 217 includes a gradient-indexed lens 225. The penta-prism 216 optically couples the fixed focusing lens system 217 to the adjustably focusing lens system 215. The elongated cavity 214 of the housing 211 has a bore 226 that is orthogonally disposed thereto at the distal end 220 thereof. The fixed focusing lens system 217 is disposed within the bore 226. The housing 211 has two parallel, orthogonally disposed cavities 227 at its distal end 220. The dental video camera 210 also includes two lamps 228 that are disposed in the two parallel, orthogonally disposed cavities 229 of the housing 211. The two lamps 228 provide direct illumination through the optical window 219 of the sheath 218. The sheath 218 has a distal end 229, a proximal end and an elongated cavity 230. The housing 211 is removably inserted into the elongated cavity 230 of the sheath 218. The adjustably focusing lens system 215 is optically coupled to the charge coupled device camera. The penta-prism 216 optically couples the fixed focusing lens system 217 to the adjustably focusing lens system 215. The optical window 219 of the sheath 218 is optically aligned and optically coupled to the fixed focusing lens system 217.

Referring to FIG. 13 in conjunction with FIG. 14 and FIG. 15 a dental video camera 310 includes housing 311, an optical system 312 and a charge coupled device camera. The housing 311 has an elongated cavity 314 that has a distal portion and a proximal portion. The optical system 312 is disposed in the distal portion of the elongated cavity 314 of the housing 311. The charge coupled device camera is disposed in the proximal portion of the elongated cavity 314 of the housing 311. The optical system 312 includes a adjustably focusing lens system 315, a fixed focusing lens system 316 and a sheath 317 which has an optical window 318.

The housing 311 has a distal end 319 and a proximal end. The adjustably focusing lens system 315 includes a first sleeve 320, a first achromatic lens and a second achromatic lens 321. A singlet lens, a doublet lens or a triplet lens may replace the first achromatic lens. The first and second achromatic lenses 321 are disposed in the first sleeve 320 and are optically coupled to the charge coupled device camera. The adjustably focusing lens system 315 is disposed within the elongated cavity 314 of the housing 311 at the distal end 319. The fixed focusing lens system 316 includes a second sleeve 322, a first micro-lens 323 and a second micro-lens 324. The first and second micro-lenses 323 and 324 are disposed in the second sleeve 322. The fixed focusing a lens system 316 is optically coupled to the adjustably focusing lens system 315. The elongated cavity 314 of the housing 311 has a bore 325 that is axially aligned therewith at the distal end 319 thereof. The fixed focusing lens system 316 is disposed within the bore 325. The housing 311 has two parallel cavities 326 disposed at its distal end 319. The dental video camera 310 also includes two lamps 327 and two bundles 328 of optical fibers. Both bundles 328 of optical fibers are disposed in the two parallel cavities 326 of the housing 311. The two lamps 327 provide light to both of the bundles 328 of optical fibers that provide direct illumination through the optical window 318 of the sheath 317. The sheath 317 has a distal end 329, a proximal end and an elongated cavity 330. The housing 311 is removably inserted into the elongated cavity 330 of the sheath 317. The adjustably focusing lens system 315 is optically coupled to the charge coupled device camera. The fixed focusing lens system 316 is optically coupled to the adjustably focusing lens system 315. The optical window 318 of the sheath 317 is optically aligned and optically coupled to the fixed focusing lens system 316.

Referring to FIG. 16 a dental video camera 410 includes housing 411, an optical system 412 and a charge coupled device camera. The housing 411 has an elongated cavity 414 that has a distal portion and a proximal portion. The optical system 412 is disposed in the distal portion of the elongated cavity 414 of the housing 411. The charge coupled device camera is disposed in the proximal portion of the elongated cavity 414 of the housing 411. The optical system 412 includes an adjustably focusing lens system 415, a fixed focusing lens system 416 and a sheath 417 that has an optical window 418. The housing 411 has a distal end 419 and a proximal end. The adjustably focusing lens system 415 includes a first sleeve 420, a first achromatic lens and a second achromatic lens 421. A singlet lens, a doublet lens or a triplet lens may replace the first achromatic lens. The first and second achromatic lenses 421 are disposed in the first sleeve 420 and are optically coupled to the charge coupled device camera. The adjustably focusing lens system 415 is disposed within the elongated cavity 414 of the housing 411 at the distal end 419. The fixed focusing lens system 416 includes a gradient-indexed lens 422. The fixed focusing lens system 416 is optically coupled to the adjustably focusing lens system 415. The elongated cavity 414 of the housing 411 has a bore 423 that is axially aligned therewith at the distal end 419 thereof. The fixed focusing lens system 416 is disposed within the bore 423. The housing 411 has two parallel cavities 424 disposed at its distal end 419. The dental video camera 410 includes two lamps 425 and two bundles 426 of optical fibers both of those are disposed in the two parallel cavities 424 of the housing 411. The two lamps 425 provide light to the bundles 426 of optical fibers that provide direct illumination through the optical window 418 of the sheath 417. The sheath 417 has a distal end 427, a proximal end and an elongated cavity 428. The housing 411 is removably inserted into the elongated cavity 428 of the sheath 417. The adjustably focusing lens system 415 is optically coupled to the charge coupled device camera. The fixed focusing lens system 416 is optically coupled to the adjustably focusing lens system 415. The optical window 418 of the sheath 417 is optically aligned and optically coupled to the fixed focusing lens system 416.

Referring to FIG. 17 an in vivo video camera system includes a swallowable capsule 510 for viewing inside the digestive system and for transmitting at least video data, a reception system 512 located outside a patient and a data processor 514 for processing the video data. The data processor 514 operates two monitors, a position monitor 516 on which the current location of the capsule 510 within the digestive system is displayed and an image monitor 518 on which the image currently viewed by the capsule 510 is displayed. The reception system 512 can either be portable, in which case, the data it receives is temporarily stored in a storage unit 519 prior to its processing in data processor 514, or it can be stationary and close to the data processor 514.

Referring to FIG. 18 in conjunction with FIG. 17 the capsule 510 includes a light source 520, a viewing window 522, a camera system 524, an optical system 526, a transmitter 528 and a power source 530. The light source 520 illuminates the inner portions of the digestive system through the camera system 524. The camera system 524 may be a charge-coupled device (charge coupled device) camera and detects the images. The optical system 526 focuses the images onto the charge coupled device camera system 524. The transmitter 528 transmits the video signal of the charge coupled device camera system 524. The power source 530 may be a battery and provides power to the entirety of electrical elements of the capsule 510. The capsule 510 can additionally include sensor elements for measuring pH, temperature and pressure. A suitable small charge coupled device camera system 524 is the 0.25″ color charge coupled device cameras of Sony Corporation of Japan. This single chip includes the charge-coupled device and the electronics for producing a video signal from the output of the charge coupled device. The charge-coupled device can either provide black and white signals or color signals. Because it is desired to view the walls of the digestive tract, the viewing window 522 typically is located on a side of the capsule 510. The optical system 526 includes a mirror 527 and a focusing lens 529. The mirror 527 is a dichroic mirror which transmits the light from the light source 520, which may be a light emitting diode, to the walls of the digestive tract via the viewing window 522. The mirror 527 deflects the light reflected from the digestive system towards the focusing lens 529. The focusing lens 529 focuses the light onto the charge coupled device camera system 524.

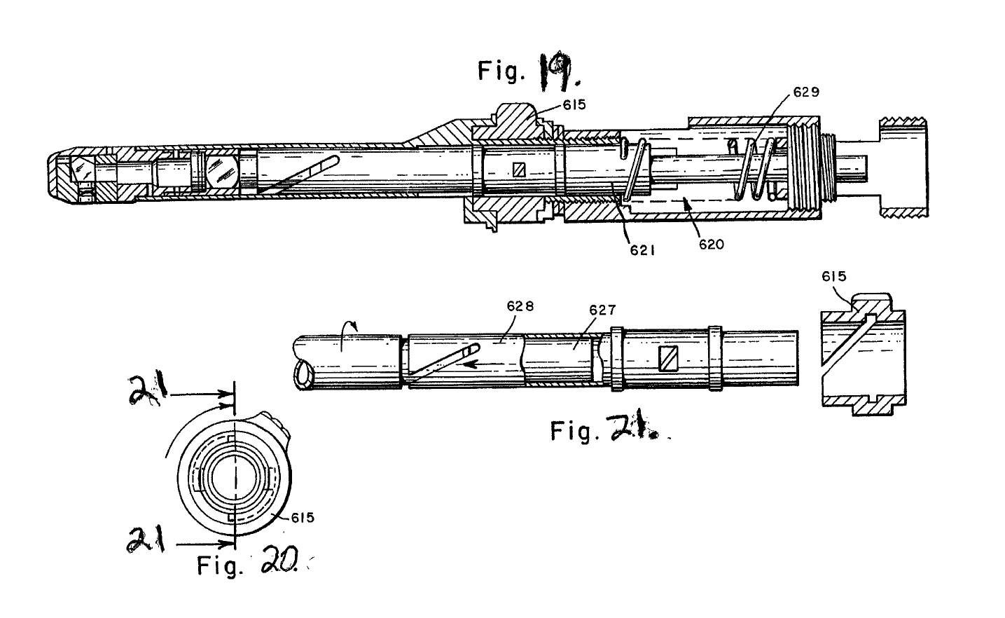

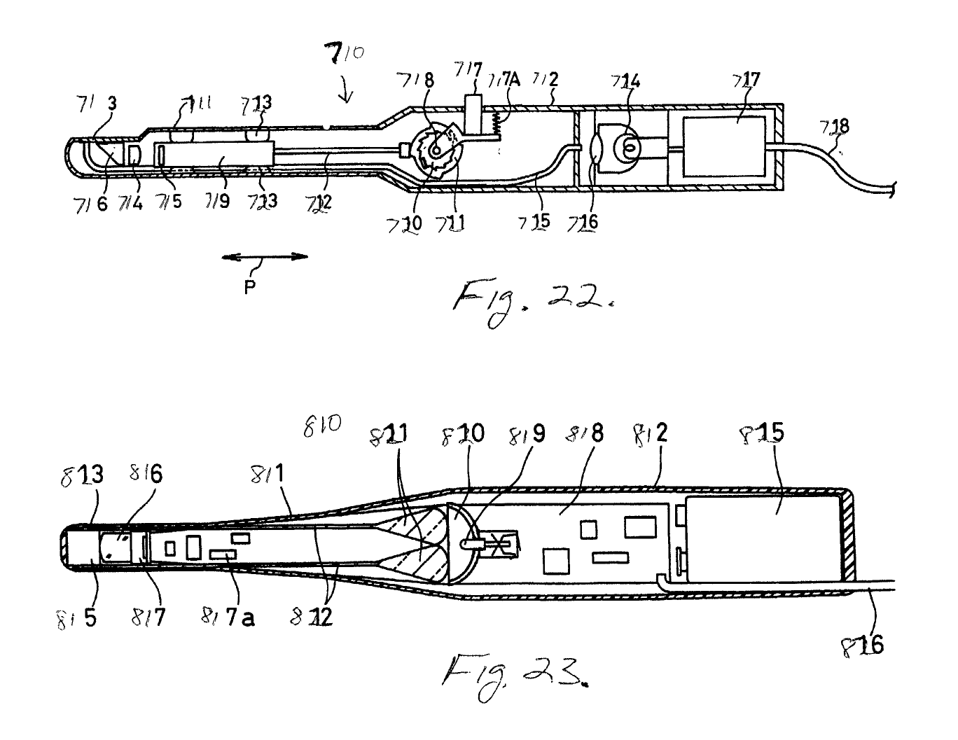

Referring to FIG. 19 in conjunction with FIG. 20 and FIG. 21 the dental video camera 610 also includes an adjustably focusing lens and charge coupled device camera system 620 that is disposed within the proximal portion 613 of the housing 611. The adjustably focusing lens and charge coupled device camera system 620 also includes a first sleeve 625 and a second sleeve 626. The first sleeve 625 has a longitudinal axis. The first sleeve 625 is axially aligned along the longitudinal axis and is disposed within the elongated cavity of the housing 611 adjacent to the fixed focusing lens system 620. The first sleeve 625 is able to rotate about the longitudinal axis and is restrained from moving laterally back and forth along the longitudinal axis. The second sleeve 626 is telescopically and slidably coupled to the first sleeve 625. The second sleeve 626 is able to move laterally back and forth along the longitudinal axis and is restrained from rotating about the longitudinal axis. The knob 615 bi-directionally drives the second sleeve 626 laterally to produce back and forth lateral movements along the longitudinal axis. A slide mechanism may bi-directionally drives the second sleeve 626 laterally to produce back and forth lateral movements along the longitudinal axis. The back and forth lateral movements of the second sleeve 626 generate clockwise and counter-clockwise rotations, respectively, of the first sleeve 625. The adjustably focusing lens and charge coupled device camera system 620 also includes a first achromatic lens, which is disposed in a first lens carrier 627, and a second achromatic lens, which is disposed in a second lens carrier 628. The first lens carrier 627 with the first achromatic lens is disposed within and coupled to the first sleeve 625. The second lens carrier 628 with the second achromatic lens is disposed within the first sleeve 625 and is fixedly coupled to the first sleeve 625. The adjustably focusing lens and charge coupled device camera system 620 further includes a spring 629. The spring 629 resiliently couples the charge coupled device camera 621 to the elongated cavity of the housing 611. The second sleeve 626 engages the charge coupled device camera 621 and laterally moves the charge coupled device camera 621 back and forth. The back and forth lateral movements of the second sleeve 626 changes the position of the charge coupled device camera 621 with respect to the first and second achromatic lenses thereby changing the field of focus. The adjustably focusing lens and charge coupled device camera system 620 provides a focusing adjustment between a near field of focus and a far field of focus. The dental video camera 610 also includes an adjustable iris 630 that is optically and mechanically coupled to the adjustably focusing lens system 620. The adjustable iris 630 is adjusted between a nearly closed opening and a wide open opening in response to the focusing adjustment between the near field of focus and the far field of focus. When the knob 615 is in the neutral position the opening of the adjustable iris 630 is between nearly closed and wide open.

Referring to FIG. 20 in conjunction with FIG. 21 when the knob 615 has been rotated counter-clockwise forty-five degrees from the neutral position the opening of the adjustable iris 630 is wide open.

Referring to FIG. 22 an intra oral video camera 710 includes an insert portion 711 that is to be inserted into the oral cavity of a patient, a grip 712 to be held by a hand of an operator or a doctor, and a cover glass 713 of an entrance window on which image light reflected from a subject becomes incident. Provided in the vicinity of the leading end of the insert portion 711 is an imaging system that includes an objective lens 714, a charge coupled device unit 715 and a prism mirror 716 for lateral vision. The objective lens 714 includes a single lens having an aspheric surface for aberration correction. An iris diaphragm with a fixed aperture is provided between the objective lens 714 and the prism mirror 716. The objective lens 714 is fixed while the charge coupled device unit 715 is movable. The grip 712 is provided with a self-reset type pushbutton 717 adapted to reciprocate by means of a spring 717A, an operation cycling mechanism 718 (intermittent rotation mechanism) adapted to rotate 1/N of a full rotation in one direction in response to one depression of the pushbutton 717, and an image pickup device moving mechanism 719 for moving the charge coupled device unit 715 along the optical path (direction indicated by an arrow P in the figure) as given a predetermined amount of displacement by the operation cycling mechanism 718. The operation cycling mechanism 718 includes a ratchet gear 720 and a rotary cam 721 as main components thereof and provides a stepwise change of displacement given to the image pickup device moving mechanism 719 in response to each depression of the pushbutton 717. By depressing the pushbutton 717 plural times (N times), the rotary cam 721 is rotated 360 degrees thereby causing the image pickup device moving mechanism 719 to resume its initial position. The image pickup device moving mechanism 719 includes a displacement transmission bar 722 and a guide 723 as main components thereof for converting a displacement caused by the rotary cam 721 into a movement of the charge coupled device unit 715. The displacement transmission bar 722 is provided with a spring mechanism for urging the displacement transmission bar 722 rightwardly as viewed in the figure and a guide in order for the displacement transmission bar 722 to be constantly pressed against the rotary cam 721. The grip 712 accommodates therein a light source 724 for illumination and a light guide 725 for guiding light received from the light source to the vicinity of the leading end of the insert portion 812 so as to allow the light to exit therefrom. The light guide 725 may be provided with a converging lens 726 or a diverging lens at the light-incident side or the light-exit side thereof, respectively. An electric circuit 727 includes an image pickup signal circuit and light source circuit that is provided within the grip 712. An electric cable 728 transmits image pick up signals and supplies electric power. Each time the operator depresses the pushbutton 717, the distance between the objective lens 714 and the charge coupled device unit 715 varies so that the imaging magnification can be instantaneously varied. Depressing the pushbutton 717 N-times causes the imaging magnification to resume its initial magnification. The rotary cam 721 is of a shape resembles a square. Each side (¼) of the circumference of the rotary cam 721 is formed with a cam surface for changing the distance between the objective lens 714 and the charge coupled device unit 715 correspondingly to three imaging magnification modes for imaging one tooth, entire mouth and whole face which are required of a video scope camera for use in dentistry. By depressing the pushbutton 717, the magnification modes for tooth, mouth and face can be selectively switched. The mode cycle is completed at every third depression of the pushbutton 717.

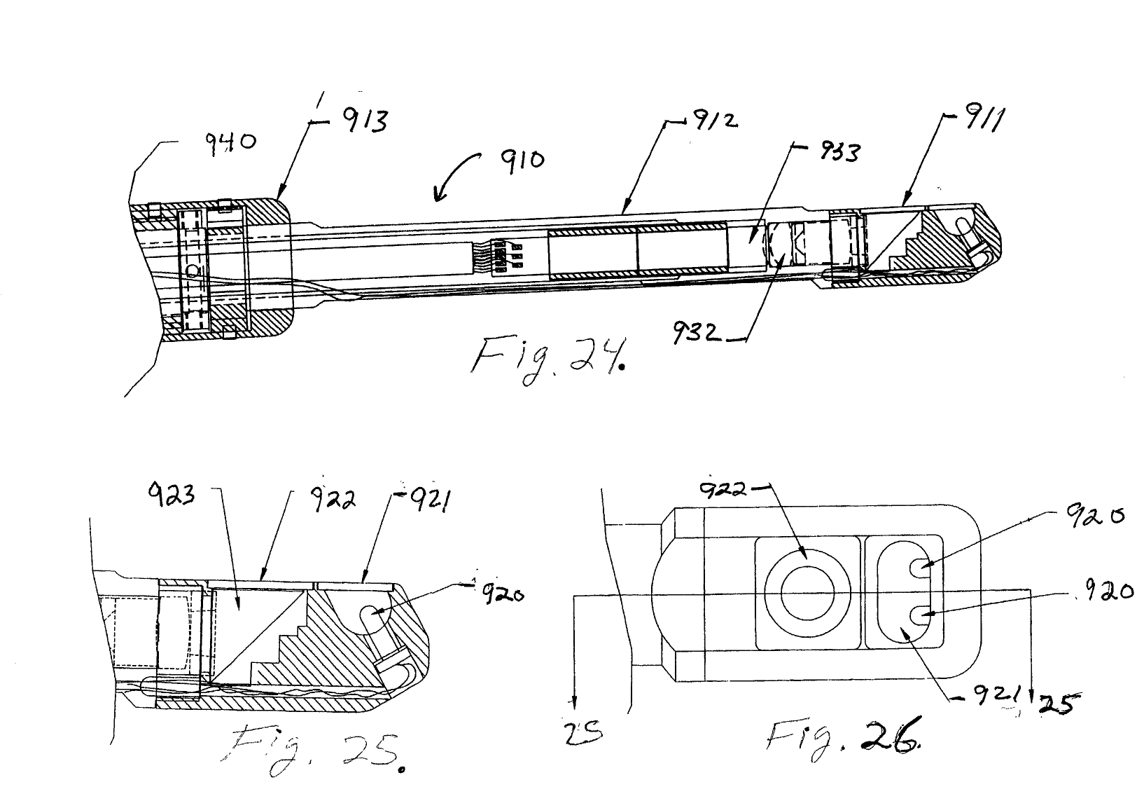

Referring to FIG. 23 a video-scope 810 that is for a dental or oral use. The video-scope 810 includes an insert portion 811 to enter an oral cavity, a grip portion 812 to be held by an operator, two light windows 814 for illuminating an object inside of the oral cavity, and an acceptance window 813 for receiving reflected light from the object are formed at the tip of the insert portion. These windows are formed in the wider side-wall of the insert portion that has an oblong profile. A prism 815 is disposed in the tip of the insert portion 811 for directing the reflected light from the object through the acceptance window 813 to charge coupled device unit 817 that is disposed in the tip of the insert portion 811 too. An object lens 816 is disposed between the prism 815 and the charge coupled device unit 817. An iris may be disposed between the prism 815 and the object lens 816. The reflected light rays from the object reach the charge coupled device unit 817 through the acceptance window 813, the prism 815 (and the iris) and the object lens 816. A video circuit 818 is disposed in the grip portion. The video circuit 818 is formed on a printed wiring board (PWB) that extends from the inside of the grip portion to the inside of the insert portion. The charge-coupled device unit 817 are mounted on the distal end of the PWB of the video circuit 818. A light source 819 for illuminating the object is disposed in the grip portion 812. Light rays emitted by the light source 819 are directed to the direction of the insert portion by a concave mirror 10 and enter each condensing portion 11 of two light guides 14. Each light guide 14 has the condensing portion 11, a guiding portion 12 and a shedding portion 13. The light guide 14 can be made of a transparent plastic such as an acrylic by molding. The light rays that enter the condensing portion 11 of the light guide 14 propagate in a guiding portion 12 and are shed from the shedding portion 13 that is located adjacent to the lighting windows 814. The condensing portion 11 of the light guide 14 has a shape that is suitable for efficiently condensing the light rays from the light source 819 and the concave mirror 10 and giving them to the guiding portion 12 of the light guide 13. The guiding portion 12 has a thin oblong profile so as to be disposed in a narrow space between the prism 815, the object lens 816, or the charge coupled device unit 817 and the side walls of the insert portion 811. The distal end of the guiding portion 12 has a reflection face angled at 45 degrees to direct the light rays to the shedding portion 13. The video-scope 810 has a battery 15 in the grip portion 812 for supplying a power to the charge coupled device unit 817 and its drive circuit 817a, the video circuit 818 and the light source 819. An alkaline battery, a lithium battery or a rechargeable battery can be used interchangeably. A video output cable 16 extends from the proximal end of the grip portion 812 for connection with a display such as a monitor TV set. The light source 819 is a halogen lamp and can be exchanged easily. The light source 819, the charge coupled device unit 817, its drive circuit 817a and the video circuit 818 are turned on and off by switches that are arranged on the grip portion. The video-scope 810 includes two light guides made of a transparent plastic material having a condensing portion, a guiding portion and a shedding portion. Therefore this video-scope 810 can be assembled easily in a low cost compared with that of the prior art while maintaining a good quality image. In addition, since the light rays propagate inside the light guide, the heat of the light rays hardly influence the charge coupled device unit and its drive circuit. The heat of the light rays also does not influence the video circuit since the concave mirror shields the video circuit from heat of the light rays. Moreover, since the charge coupled device unit is disposed in the tip of the insert portion, an optical fiber or other means for transmitting the image from the object to the charge coupled device unit can be eliminated without deterioration of the image quality. Mounting the charge coupled device unit, its drive circuit and the video circuit on the single PWB facilitates assembling of the video-scope as well as adjusting electric characteristics. The video-scope is easy to handle since only a thin video cable is extended from the proximal end of the grip portion and the insert portion can be thin enough to move in the mouth cavity.

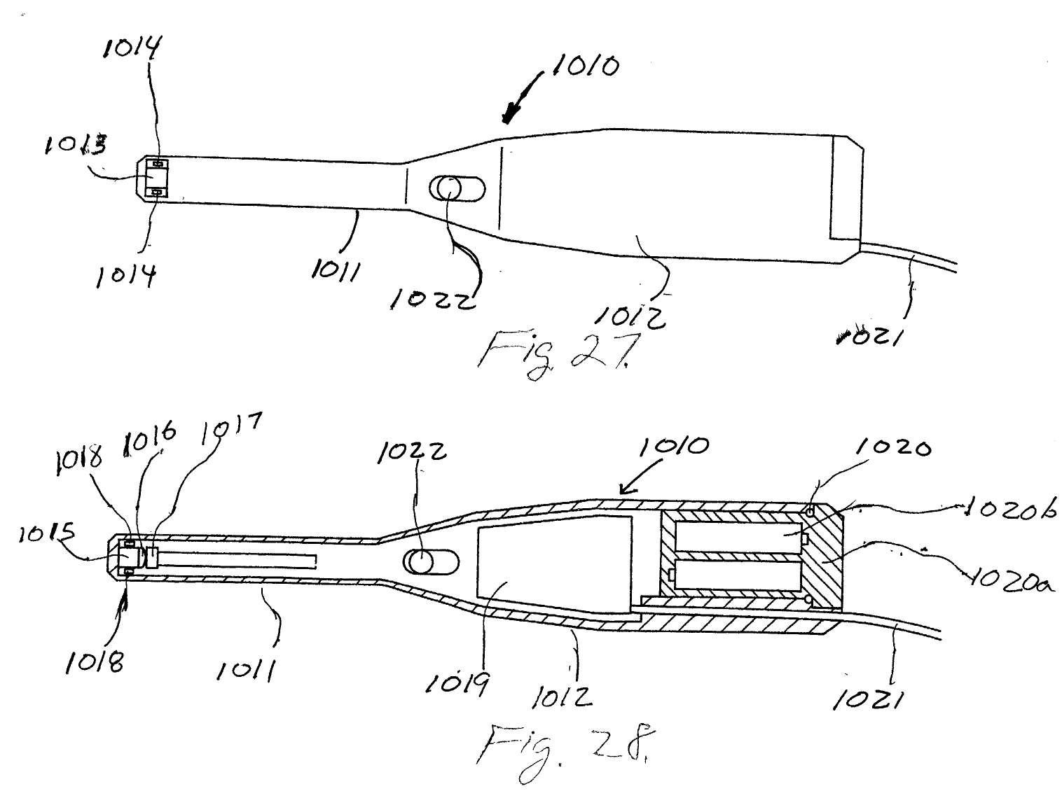

Referring to FIG. 24 in conjunction with FIG. 25 and FIG. 26 a hand-piece 910 includes an imaging window 922 and light sources 920. The imaging window receives light reflected by the subject. The light sources 920, which are located distal to the imaging window 922 and are covered by a protective glass shield 921, are aimed so that they will provide illumination for subjects located below the window. A prism 923 is located within the distal end of the hand-piece 921, angled in relation to the imaging window 922 to direct the light arriving through the imaging window in the direction of the proximal end of the hand-piece 910. Of course, instead of using an individual imaging window 922 and shield 921, as depicted in the figure, a single piece of material may be used as both the window and the shield. In this configuration, the material would have a window portion and a shield portion distal to the window portion. A wide variety of lamps may be used. A low power, long life lamp is preferable to save power and minimize service calls and system down time. A suitable lamp may be an incandescent light bulb, such as Gilway Technical Lamp #4115 or a “white light emitting diode”. This white light emitting diode could include a short-wavelength LED combined together with a phosphorescent coating, such as Nichia America #NSCW-100. The “white light emitting diode” could also include a set of three single color light emitting diodes (e.g., red, green, and blue), mounted in a single package, such as Nichia America #NSCM-310. While two lamps are depicted in the figure, any number of lamps may be used. In addition to generating light, the lamps also generate some heat. This is advantageous in dental applications, because it helps clear away condensation that could form from a patient's breathing on a cold instrument. By locating the lamps in the distal end of the hand piece, distal to the imaging window, and angling the lamps so as to provide direct illumination of the object being imaged, the diameter of the housing can be minimized. This allows the hand piece to be contained within a slimmer housing, as compared to other cameras which have light sources positioned above the imaging window, such as the one described in U.S. Pat. No. 4,575,805. A slimmer device is advantageous for dental use. Alternative light source arrangements may also be used. The median section 912 of the hand-piece 919, which houses the lens system 932, the image sensor 933, and the focusing mechanism 913. The lens system 932 is preferably a fixed-focus lens system. The image sensor 933 is preferably either a charge coupled device (charge coupled device) or an APS (active pixel sensor array). The lens system 932 is located in the distal portion of the median section 912, proximal to the distal end of the hand-piece 911. The movable image sensor 933 is located proximal to the fixed lens system 932. The lens system 932 transmits the light arriving from the distal end of the hand-piece 911 to the active surface of the image sensor 933. The lens system 932 may be replaced by another type of light direction means including, for example, a mirror, a prism, and an optical fiber. The movable image sensor 933 is controlled by a plunger system that is attached to the focusing ring 913. The focusing ring 913 can be manually rotated into any of a plurality of detented positions that correspond to a plurality of image sensor positions.

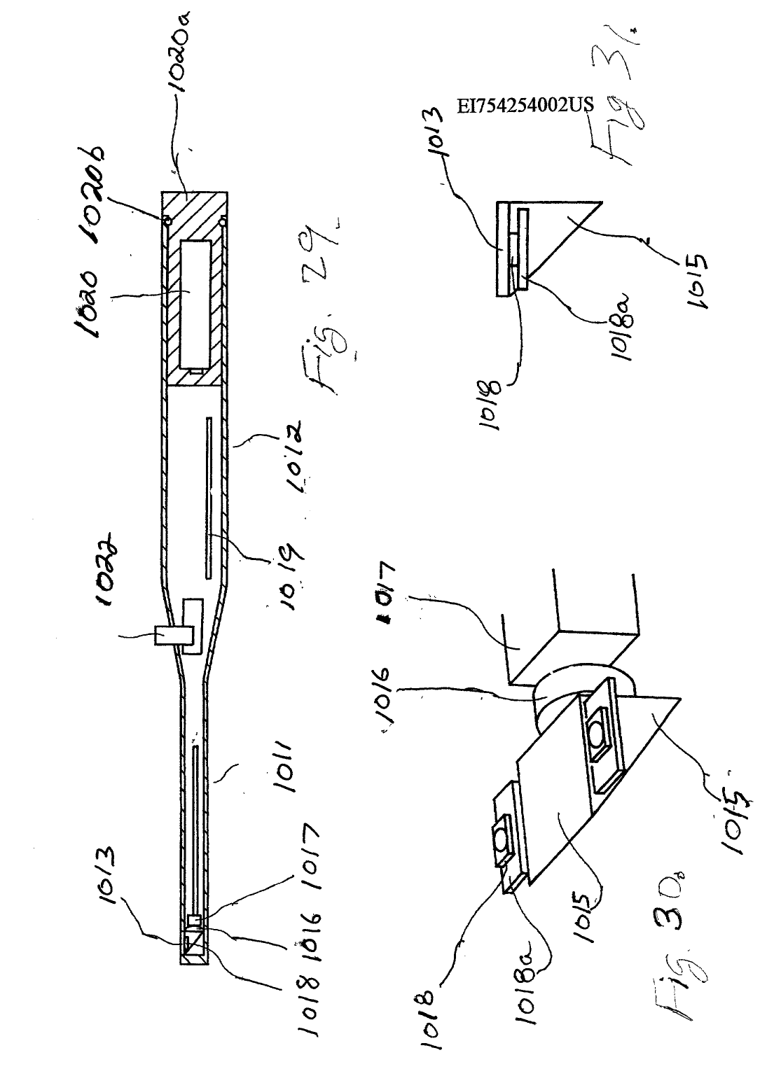

Referring to FIG. 27 in conjunction with FIG. 28, FIG. 29, FIG. 30 and FIG. 31 a video scope 1010 includes an entry section 1011 that is to advance into an oral cavity and a grip section 1012 that is to be held by a hand of an operator. A window of incidence 1013 that is made of a light transmissive glass material, resin material or the like is hermetically fixed to a side surface of the entry section 1011 in the vicinity of a tip thereof, and an image pickup system that consists of a prism mirror 1015 used as an example of reflecting body for sideward observation, an objective lens 1016 and a charge coupled device unit 1017 is built in the tip of the entry section 1011. Illumination windows 1014 for light projection are disposed on both sides of the window of incidence 1013 so that illumination rays emitted from surface mount type white light emitting diodes 8 (Nichia Chemical Industries, Co., Ltd.) mounted on a substrate 8a are projected to the illumination windows 1014. The white light emitting diodes 1018 are arranged on both sides of the prism mirror 1015 and fixed in close contact with the illumination windows 1014. Top surfaces of the light emitting diodes 1018 are flush with a top surface of the prism mirror 1015. The illumination rays are projected directly to the illumination windows 1014 so that they are lost at a low ratio and used efficiently. Further, the white light emitting diodes 1018 are molded integrally with the illumination windows 1014 to reduce a number of required parts and simplify assembling procedures. The white light emitting diodes 1018 are used as a light source so that power consumption is lower than that of lamps. The white light emitting diodes 1018 have a long service life and require no exchange with new ones. An iris diaphragm may be arranged between the objective lens 1016 and the prism mirror 1015. Disposed in the grip section 1012 are a camera circuit 1019 which operates the charge coupled device unit 1017 and the white light emitting diodes 1018, and a power source 1020 which drives the camera circuit 1019 and the white light emitting diodes 1018. Built in the camera circuit 1019 are a voltage detection circuit which detects a voltage drop in the power source 1020 below a predetermined level, a flickering circuit which flickers the white light emitting diodes 1018 and a video output interception circuit which turns off a video output. While the power source 1020 supplies a voltage at a sufficient level, the white light emitting diodes 1018 always stay lit so far as the video output is turned on. When the power source supplies a voltage lower than the predetermined level, however, the voltage detection circuit actuates and flickers the white light emitting diodes 1018 and turns off the video signals with the video signal interception circuit. Usable as the power source 1020 is low voltage cells such as alkaline batteries, lithium cells or rechargeable cells. These cells are exchangeably mounted in a power source holder 1020a over which a watertight O-ring 1020b is fitted and the power source holder 1020a is set in the grip section 1012. A combination of a detachable cell pack and a charger may be used as the power source 1020. A video output cable 1021 which is to be connected to a display such as a monitor TV is taken out of a rear portion of the grip section 1012. A section of this video output cable which ranges rearward from inside the grip section 1012 is made watertight. A reference numeral 1022 represents a switch that is water-tightly disposed on the grip section 1012 to facilitating to check teeth for tartar and decayed conditions.

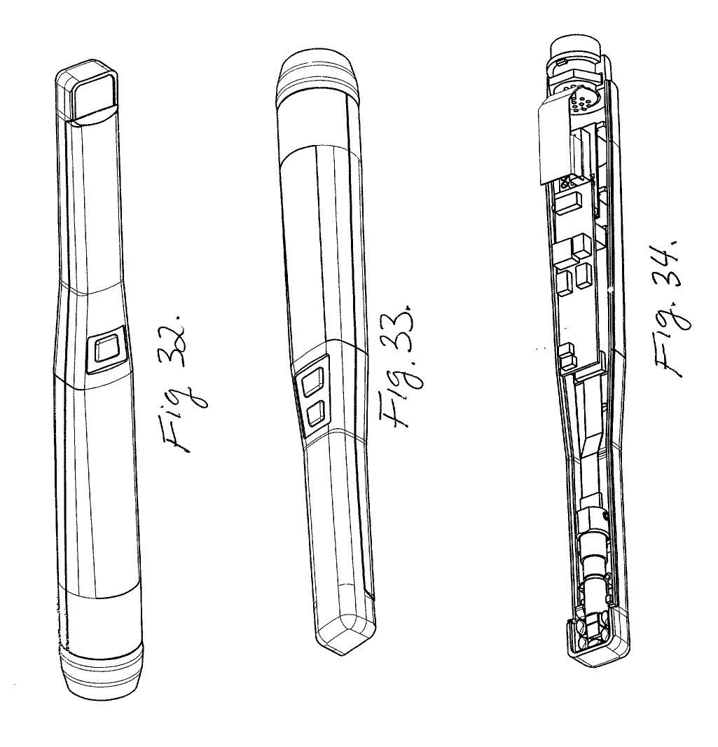

Referring to FIG. 32 in conjunction with FIG. 33 and FIG. 34 a dental video camera 1110 includes housing 1111, an adjustably focusing lens and CCD camera system 1112, an iris 1113, a plurality of light emitting diodes 1114, a circuit board 1115 and video-processing circuitry 1116 and a flexible, electrical cable 1117. The housing 1111 has an elongated cavity with a distal end and a proximal end. The adjustably focusing lens and CCD camera system 1112 is disposed within the elongated cavity of the housing 1111. The adjustably focusing lens and CCD camera system 1112 provides a focusing adjustment between a near field of focus and a far field of focus. The iris 1113 may be adjustable optically and is mechanically coupled to the adjustably focusing lens and CCD camera system 1112. The iris 1113, if adjustable, is a stretchable disc of material with a center pin-hole which slidable portion of the adjustably focusing lens and CCD camera system 1112 adjusts between a nearly closed opening and a wide open opening in response to the focusing adjustment between the near field of focus and the far field of focus. There may be a fixed focusing lens system optically which may be coupled to the adjustably focusing lens and CCD camera system 1112 and which is disposed in the elongated cavity of the housing 1111.

Referring to FIG. 36 in conjunction with FIG. 37 the adjustably focusing lens and CCD camera system 1112 is a focused camera assembly 1120 which includes a sleeve 1121, a focusing lens system 1122 and a charge coupled device 1123. The sleeve is slidably coupled to the housing 1111. The focusing lens system 1122 and the charge-coupled device 1123 are disposed in the sleeve 1121. The charge-coupled device 1123 is electrically coupled to the circuit board 1115 and the video-processing circuitry 1116 through the flexible, electrical cable 1117. The focusing lens system 1122 is carried on the front cover and focuses onto the imager an image of an object in its field of view. The light emitting diodes 1114 are carried on the head member and direct illumination from the lamps into the field of view. The electrical conduit carries power to the video processor circuitry and to the light emitting diodes and carries from the video processor circuitry a video signal that represents the object in the field of view.

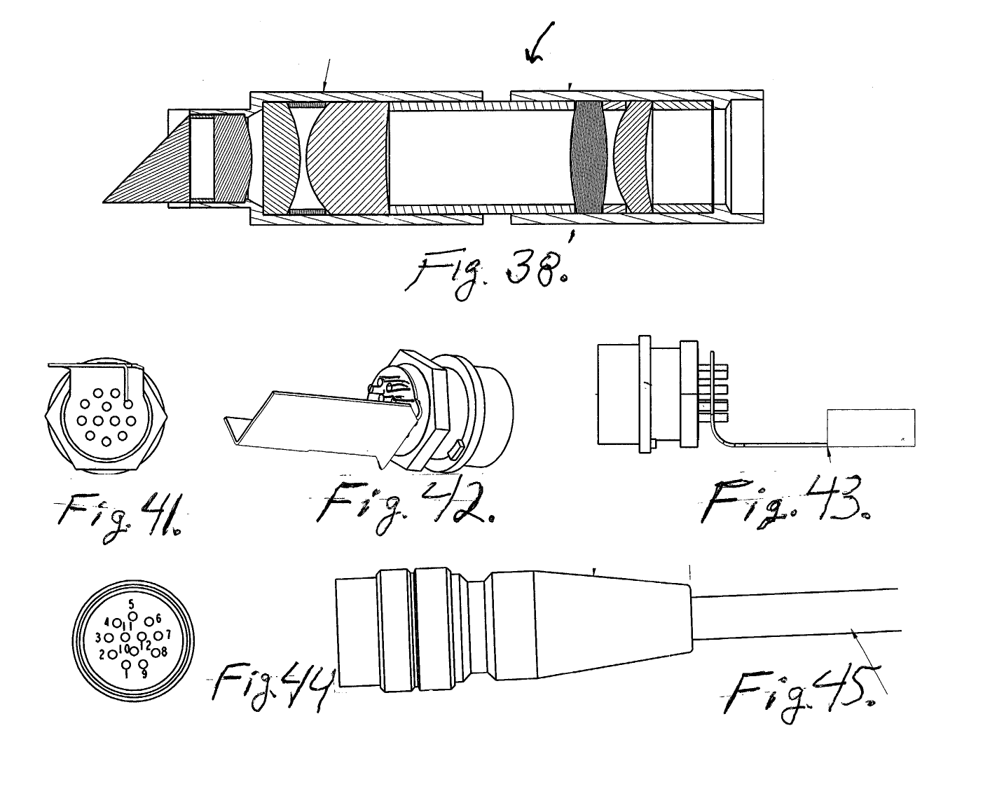

Referring to FIG. 38 in conjunction with FIG. 36, FIG. 39 and FIG. 40 the focusing lens system 1123 includes a sleeve 1131, a lens carrier 1132, achromatic-lenses 1133 that are disposed in a slidable portion, fixed lenses 1134 that are disposed in a fixed portion and an iris 1135. The sleeve 1131 is coupled to the housing 1111. The sleeve 1131 is able to move laterally back and forth. The lens carrier 1132 has achromatic lenses 1133 and fixed lenses 1134. The sleeve 1131 engages the charge-coupled device so that the sleeve 1131 laterally moves the charge coupled device back and forth in order to change the position of the charge coupled device with respect to the achromatic lenses 1133 and the fixed lenses 1134 thereby changing the field of focus.

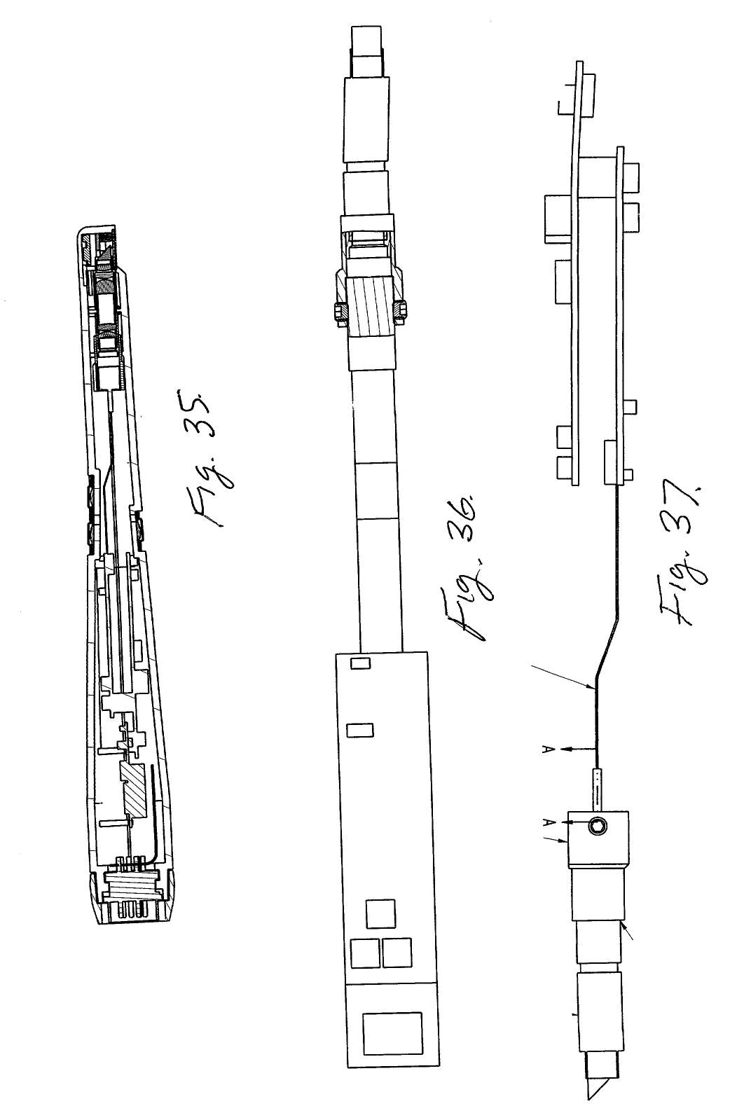

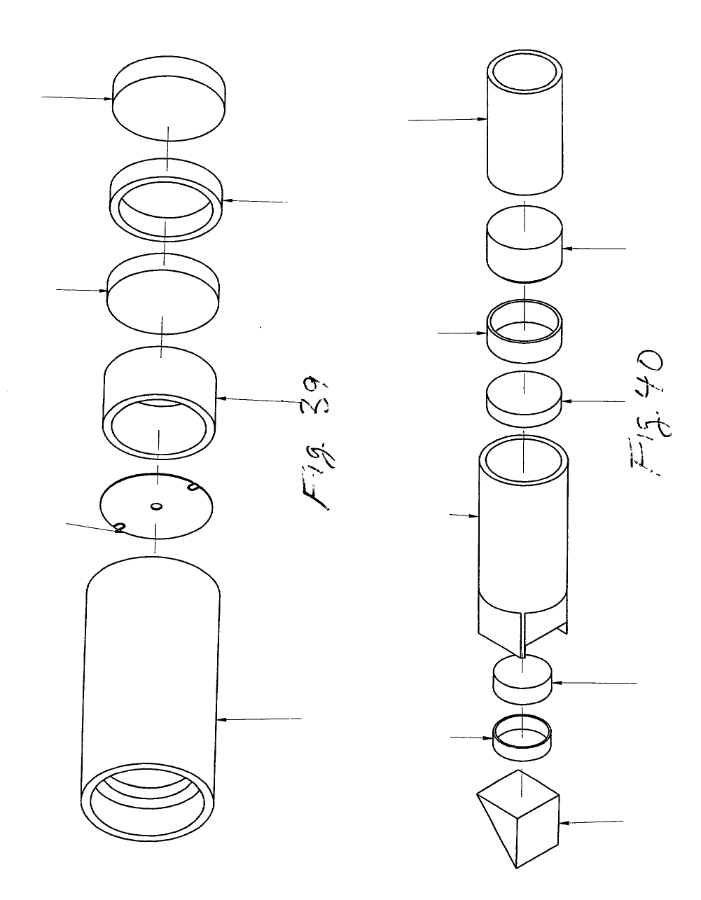

Referring to FIG. 41 in conjunction with FIG. 35, FIG. 41, FIG. 42 and FIG. 43 a cable connector assembly 1140 includes female connectors 1141 and a flexible circuit board 1142. The flexible circuit board 1142 is electrically coupled to a circuit for the charge-coupled device 1143.

Referring to FIG. 44 in conjunction with FIG. 45 a cable 1150 may be electrically coupled to the cable connector assembly of FIG. 35.

From the foregoing it can be seen that a dental video camera has been described. It should be noted that the sketches are not drawn to scale and that distances of and between the figures are not to be considered significant.

Accordingly it is intended that the foregoing disclosure and showing made in the drawing shall be considered only as an illustration of the principle of the present invention.

What is claimed is:

1. A dental video camera comprising:
a. a housing having an elongated cavity having a proximal end and a distal end;
b. a fixed lens system disposed within said elongated cavity;
c. an adjustably focusing lens and CCD camera system disposed within said elongated cavity, said adjustably focusing lens and CCD camera system including:
i. a sleeve slidably coupled to said housing within said elongated cavity whereby said sleeve is able to move laterally back and forth;
ii. an adjustable fixed lens system disposed within said sleeve; and
iii. a charge-coupled device disposed within said sleeve whereby said sleeve laterally moves said adjustable focusing lens and CCD camera system back and forth in order to change the position of said adjustably focusing lens and CCD camera system with respect to said fixed lens system thereby changing the field of focus;
d. a mechanism coupled to said housing whereby said mechanism bi-directionally drive said sleeve laterally to produce back and forth lateral movements; and
e. a plurality of lamps mechanically coupled to said housing at said distal end.

2. A dental video camera according to claim 1 wherein said dental video camera includes a pentaprism which optically couples said adjustably focusing lens and CCD camera system to said fixed focusing lens system and which is disposed in said elongated cavity of said housing at said distal end.

3. The dental video camera according to claim 1 wherein each of said lamps comprises a light emitting diode.

4. The dental video camera according to claim 1 wherein each of said lamps comprises a white light emitting diode.

5. The dental video camera according to claim 1 wherein said dental video camera comprises:
a. a battery disposed in said housing; and
b. a transmitter disposed in said housing whereby said transmitter transmits the video output of said dental video camera.

6. A dental video camera comprising:
a. a housing having an elongated cavity having a proximal end and a distal end;
b. an fixed lens system disposed within said elongated cavity;
c. an adjustable CCD camera system disposed within said elongated cavity, said adjustable CCD camera system including:
i. a sleeve slidably coupled to said housing within said elongated cavity whereby said sleeve is able to move laterally back and forth; and
ii. a charge-coupled device disposed within said sleeve whereby said sleeve laterally moves said CCD camera system back and forth in order to change the position of said charge coupled device with respect to said fixed lens system thereby changing the field of focus;
d. a mechanism coupled to said housing whereby said mechanism bi-directionally drive said sleeve laterally to produce back and forth lateral movements; and
e. a plurality of lamps mechanically coupled to said housing at said distal end.

7. A dental video camera according to claim 6 wherein said dental video camera includes a pentaprism which optically couples said adjustable CCD camera system to said fixed focusing lens system and which is disposed in said elongated cavity of said housing at said distal end.

8. The dental video camera according to claim 6 wherein each of said lamps comprises a light emitting diode.

9. The dental video camera according to claim 6 wherein each of said lamps comprises a white light emitting diode.

10. The dental video camera according to claim 6 wherein said dental video camera comprises:
a. a battery disposed in said housing; and
b. a transmitter disposed in said housing whereby said transmitter transmits the video output of said dental video camera.
